(19) United States
(12) Patent Application Publication
(10) Pub. No.: US 2026/0061715 A1
(43) Pub. Date: Mar. 5, 2026

(54) CONTROL METHOD FOR CONTROLLING THE OPERATING CONDITIONS OF A PRESS MACHINE

(71) Applicant: I.M.A. INDUSTRIA MACCHINE AUTOMATICHE S.P.A., Ozzano dell'Emilia (BO) (IT)

(72) Inventors: Fabrizio Salvatore Consoli, Ozzano dell'Emilia (BO) (IT); Filippo Zaniboni, Ozzano dell'Emilia (BO) (IT)

(73) Assignee: I.M.A. INDUSTRIA MACCHINE AUTOMATICHE S.P.A., Ozzano dell'Emilia (BO) (IT)

(21) Appl. No.: 19/123,432

(22) PCT Filed: Oct. 2, 2023
(86) PCT No.: PCT/IB2023/059852

§ 371 Date: Apr. 23, 2025

(30) Foreign Application Priority Data
Nov. 7, 2022 (IT) 102022000022863

(51) Int. Cl. B30B 11/00; B30B 11/08; B30B 15/00

(52) U.S. Cl. CPC B30B 11/006; B30B 11/08; B30B 15/0094

(57) ABSTRACT

Control method for controlling the operating conditions of a rotary press machine (1) for forming tablets (100), wherein the rotary press machine (1) comprises a rotating compression turret (2) which includes a die table (3) provided along a circumferential portion thereof with a plurality of dies (4), a plurality of lower punches (6) and a corresponding plurality of upper punches (5) associated in pairs with respective dies (4), said lower punches (6) and said upper punches (5) respectively having a substantially cylindrical body equipped with an abutment end on which a lower compression roller (12) and an upper compression roller (11) respectively abut, a feeding station (7), a control system (20) to control the operating pressure of said lower and upper compression rollers (12, 11), in which during a detection phase the feeding of powder (50) into the dies (4) is inhibited so as to have at least one empty die (4a), said lower (6) and/or upper (5) punches are moved towards said at least one empty die (4a) by means of respective lower and/or upper compressing means, and a resisting pressure value is measured, by means of detection means (14), as the value of pressure exerted by the respective lower and/or upper compression means on the corresponding lower and/or upper punches (6, 5) moved inside said at least one empty die (4a), and an evaluation phase in which a value of said resisting pressure is processed by said control system (20) to generate a signal relating to a punch operating state.

The present invention relates to a control method for controlling the operating conditions of a press machine for producing tablets, pellets, pills, for example for pharmaceutical, cosmetic, food, chemical use, by compressing powder or granules. In particular, the invention relates to a method for operating a rotary press machine in an evaluation step of the machine operation.

Rotary press machines comprising a compression turret, rotating around a vertical axis and formed by a die table or plate provided with a plurality of dies, or through cavities, angularly distributed and equally spaced along a rim or on a circumferential portion thereof and arranged to receive powder or granules dispensed in a suitable feeding station are known.

The turret further comprises a plurality of upper punches and lower punches associated with the respective dies and moved vertically by cams and compression rollers during rotation of the turret.

The lower punches form with the dies respective seats or housings suitable for receiving the powder at the feeding station. The upper punches and the lower punches compress the powder introduced into the dies to make the tablets, which are then extracted from the die table by means of the properly raised lower punches and conveyed into an outfeed chute.

The various steps for making a tablet are performed during at least a portion of one revolution of the compression turret which continuously rotates.

During a machine assembly step or a maintenance or format change steps, the operator proceeds installing of one or more punches on the machine. In this step, the correct positioning of the punch or punches mounted on the turret is verified by the operator. A positive result of this step is however strongly influenced by skills and knowledge of the operator. An error during the assembly step, for example by not inserting all the punches in respective turret housings, or by wrongly installing the punches, can lead to problems such as possible dispersions of powder in the machine, malfunctions or even breakages of the machine, resulting in an unwanted halt production necessary to restore correct functioning.

Furthermore, the punches slidingly associated with the dies have to smoothly slide therewithin at each production cycle, without producing an excessive friction which would lead to premature wear of involved mechanical members or to a potential breakage within the production cycles series. A friction that is not maintained within certain limits also leads to a temperature rise of the involved mechanical parts, with a possible negative influence on the powder that comes into contact with them.

Sensors are provided to detect the compression force of the powder, by monitoring its quality during tablet production.

A drawback of these rotary press machines, which use one or more sensors for monitoring the compression force exerted by the punches on the powder during transformation into tablets, is that an operating status information for each punch is not present. In fact, when a pressure value outside an admissible range is measured, an error not directly attributable to a specific punch is signaled. Furthermore, these machines do not give any information on the correct site assembly of the punches done before the production step nor if all the punches have been mounted or not.

An object of the present invention is to improve known tablet press machines, in particular rotary press machines having a compression turret provided with dies and punches and provided with means for monitoring a compression force.

Another object of the present invention is to provide a method for detecting the presence or absence of a punch associated with a given die before a production step, i.e. after an assembly or maintenance step of a tablet press machine, in order to avoid smudging with dust dispersed on the die table.

A further object is to prevent any punches incorrectly mounted on the machine or having the wrong size from causing damage to the press machine.

A first aspect of the invention provides a control method for controlling the operating conditions of a rotary tablet press according to claim 1.

The invention can be better understood and implemented with reference to the attached drawings which illustrate an exemplifying and non-limiting embodiment, in which:

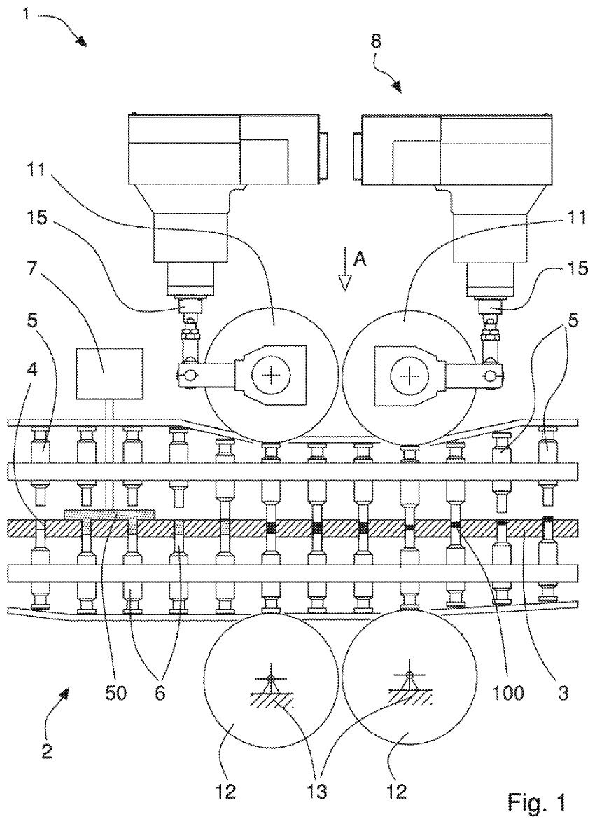

FIG. 1 is a schematic view of a rotary press machine according to the invention;

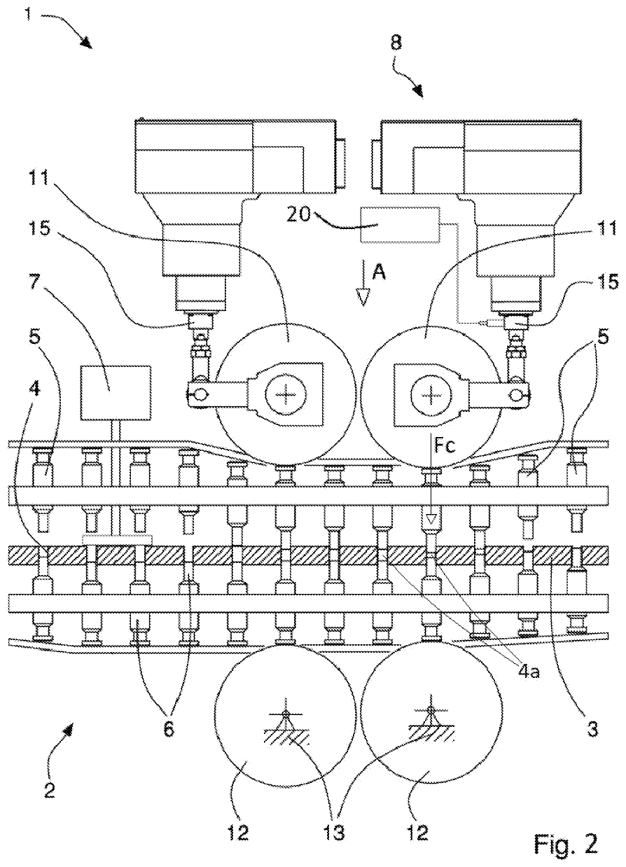

FIG. 2 is a schematic view of the rotary press machine as in FIG. 1 during a detection step;

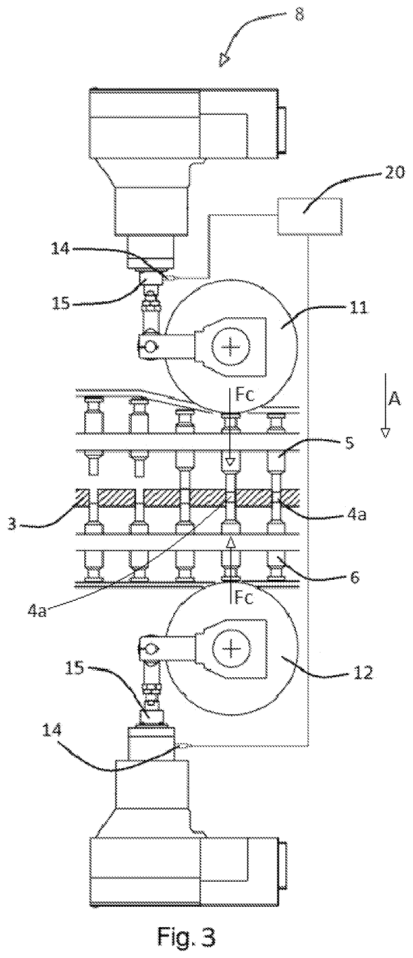

FIG. 3 is an enlarged view of a compression station of the rotary press machine according to a different embodiment;

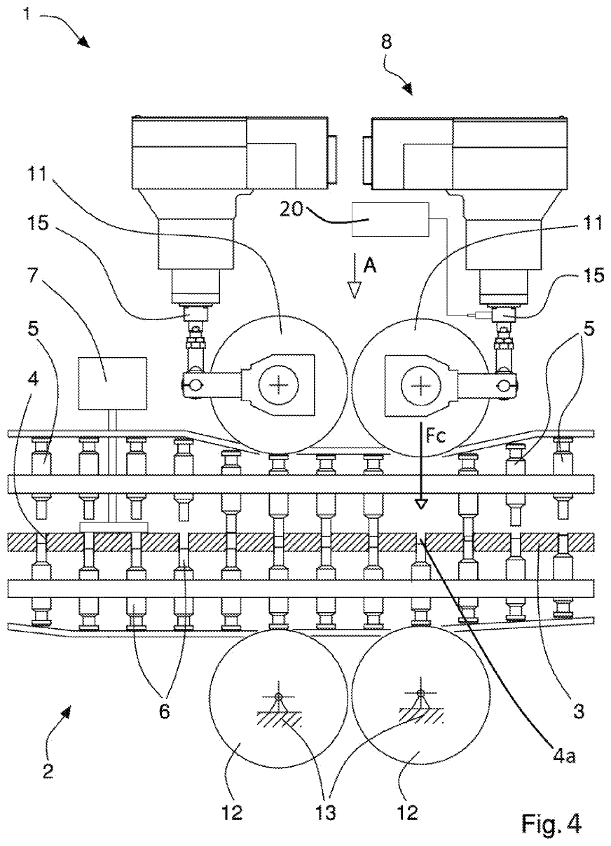

FIG. 4 is a schematic view of the rotary press machine as in FIG. 2 with a missing punch;

With reference to FIG. 1, a rotary press machine 1 according to the invention is illustrated, arranged to produce tablets, pellets, pills, by compressing powder or granules for pharmaceutical, cosmetic, food or chemical use.

The rotary press machine 1 comprises a compression turret 2 which rotates about a vertical axis of rotation (not shown) and which includes a die table 3, provided along a portion or circumferential rim thereof with a plurality of dies 4, a plurality of upper punches 5 and a corresponding plurality of lower punches 6 associated with respective dies 4. These upper and lower punches 5, 6 are movable to compress powder 50 introduced into the dies 4 so as to make tablets 100, pellets or pills.

The dies 4 are through cavities made in the die table 3 which form, in cooperation with the lower punches 6, the seats or housings in which the powder 50 is fed and subsequently compressed to form the tablets 100.

The rotary press machine 1 comprises a feeding station 7 comprising filling means for filling said dies and arranged to dispense the powder 50 to be compressed inside the dies 4 and at least one compression station 8, or main compression station, provided with an upper compression roller 11 and a lower compression roller 12 adapted to respectively actuate the upper punches 5 and the lower punches 6 along a compression direction A inside the respective dies 4 to compress the powder 50 dispensed into the dies 4 and form the tablets 100. Said lower punches 6 and said upper punches 5 having respectively a substantially cylindrical body with an abutment end on which the lower compression roller 12 and the upper compression roller 11 respectively abut.

In the embodiment illustrated in the figures, the compression direction A is substantially vertical, i.e. parallel to the rotation axis of the compression turret 2. For simplicity, in the figures is shown only an arrow A pointing downwards, but clearly the powder 50 is also compressed by the lower punches 6.

The compression station 8 also comprises an actuator 15 connected to, and acting on, the upper compression roller 11 in order to keep the upper compression roller 11 in a fixed operating position so that said upper compression roller 11 constrains the upper punches 5 to exert a compression force Fc on the powder 50 in the respective dies 4. The compression station 8 can further comprise, as visible in FIG. 3, a further actuator 15 connected to, and acting on, the lower compression roller 12 in order to keep the lower compression roller 12 in a fixed operating position so that said lower compression roller 12 constrains the lower punches 6 to exert a further compression force Fc on the powder 50 in the respective dies 4. Alternatively, the lower compression roller 12 can be rotatably mounted to a support frame 13 of the rotary press machine 1, as visible in FIGS. 1, 2 and 4.

During operation of the rotary press machine 1, in an operating condition in which the upper punches 5 in their movement within the respective dies 4 oppose to the upper compression roller 11 a resisting pressure which is less than or equal to the compression force Fc, the actuator 15 keeps the upper compression roller 11 in a fixed operating position along the compression direction A. In this way, during the rotation of the compression turret 2, the upper punches 5 are progressively engaged by the upper compression roller 11 and pushed by the latter inside the dies 4 so as to compress the powder 50 against the beneath lower punches 6.

The rotary press machine 1 also comprises detection means 14 for measuring the resisting pressure to the compression force Fc of the punches when the latter are moved along the compression direction A.

As better explained in the following description, the rotary press machine 1 is operated according to an operating method having the purpose of monitoring its correct operation. More precisely, the operating method described has the purpose of detecting the presence of all the punches 5, 6 on the compression turret 2 and further verifying their correct assembly/operation.

During the production of tablets, a step of feeding the powder 50 through said feeding station 7 into the dies 4 is performed. In this step, the lower punch 6 associated with the respective die 4 to be filled operate as a bottom wall, creating a temporary chamber into which the powder 50 to be compressed arrives. The amount of powder 50 which occupies the die 4 depends on the positioning of the lower punch 6 in the die 4, as well as on the size of the die 4.

It is clear that the term powder 50 also refers to granules or the like.

Subsequently is provided a step of compressing said powder 50 once it has been fed into the dies 4. The compression of the powder 50 takes place by moving respective lower 6 and upper 5 punches by imparting said compression force Fc, wherein the latter depends on the position of the lower 12 and upper 11 compression rollers on which said abutment ends of the lower 6 and upper 5 punches respectively abut.

An aspect of the method in accordance with the present invention is provided by a detection step in which the powder 50 fed by the feeding station 7 into the dies 4 is inhibited, i.e. interrupted, as shown in FIG. 2, so as not to have any powder 50 inside the dies 4, obtaining at least one empty die 4a. A movement of the lower 6 and upper 5 punches is then activated. It is clear that the upper and lower punches 5, 6 which have been moved are those associated with one or more empty dies 4a into which the powder 50 has not been fed. While the pair of lower 6 and upper 5 punches are moved towards the empty die 4a, a resisting pressure value is measured by detection means 14 as a pressure value exerted by the respective lower and upper compression means on the corresponding punches 5, 6 in the absence of the powder 50 to be compressed inside the respective empty die 4a.

In the specific implementation depicted in FIG. 2, the lower and upper compression means correspond with the lower 12 and upper 11 compression rollers respectively.

According to the specific embodiment in which the compression means correspond with the compression rollers, in said detection step, the detection means 14 are arranged as a plurality of sensors associated with the lower 12 and upper 11 compression roller. According to one aspect of the present invention, said detection means 14 are connected to said actuator 15. Furthermore, said detection means 14 can comprise at least one load cell. According to other embodiments, said detection means 14 can comprise one or more encoders and/or one or more piezoelectric sensors. In general, the detection means 14 can comprise one or more sensors of the known type suitable for measuring a pressing force and for transforming the measured pressing force into an associated electrical signal.

According to a further aspect of the present invention, the detection means 14 can be connected to any component connected to said lower 12 and/or upper 11 compression roller according to a configuration that allows the measurement of the resisting pressure value exerted by the respective lower 12 and/or upper 11 compression roller on the corresponding lower and/or upper punches 6, 5.

According to a specific embodiment, said compression means can be arranged on the machine 1 as supplementary compression means alongside the lower 12 and upper 11 compression roller.

This detection step can be carried out in static condition, i.e. without rotating the compression turret 2. Alternatively, it can be performed by moving the turret 2 at a speed that is very limited with respect to the usual speed during production of the tablets, for example in the order of about 1% with respect to the usual production speed. Furthermore, also the speed at which the punches 5, 6 are moved along the compression direction A is preferably very limited compared to the usual speed during production of the tablets, for example in the order of about 1% with respect to the usual production speed.

When said detection step is carried out by rotating the compression turret 2, the rotary motion of the compression turret 2 causes the lower 6 and upper 5 punches to translate vertically parallel to the compression direction A, when these punches abut against the compression means (lower 12 and/or upper 11 compression rollers), where, by means of said detecting means 14, the resisting pressure value is measured.

When said detection step is carried out in static condition, the compression means can be moved towards the respective punches. More specifically, by means of one or more actuators, the compression means are moved towards the respective abutment ends of the lower 6 or upper 5 punches. The motion imparted to the compression means can be along an horizontal axis and therefore parallel to the die table 3, or vertical, parallel to the compression direction A. According to a further embodiment, during said detection step, both the compression means and the compression turret 2 can be jointly moved.

According to the present invention, an evaluation step is carried out in which said resisting pressure value is processed by a control system 20 to generate a signal correlated to a punch operating state.

The control system 20 processes the acquired resisting pressure value by comparing it with suitable predefined thresholds and determines the status of the relative lower 6 and/or upper 5 punches.

According to another aspect of the present invention, said evaluation step comprises a data saving sub-step in which the resisting pressure values acquired during multiple detection steps for a specific empty die 4a are saved in a data storage unit.

Preferably in said data saving sub-step, the resisting pressure values acquired during multiple detection steps are aggregated to a corresponding empty die 4a for which they were measured, and to a data relating to the instant of measurement, generating an aggregate data which is saved in said data storage unit.

Said data storage unit can be included in the control system 20. Alternatively, said data storage unit can be a separate unit from the control system 20. Said data storage unit can be configured as a physical memory of the known type and/or can be configured as a cloud system.

It is clear that by repeating the detection and evaluation step N times on specific empty die 4a, N resisting pressure values measured over time are obtained. The variation of the resisting pressure in a plurality of detection steps determines a trend of the resisting pressure over time for a specific empty die 4a.

Preferably in said evaluation step, the resisting pressure value acquired during the detection step N can be compared with one or more of the N-1 resisting pressure values previously acquired and saved in the data storage unit, where N is the total number of resisting pressure measurements carried out on the specific empty die 4a.

According to a specific embodiment, said signal correlated to a punch operation state comprises a command to stop the rotary press 1, so that the operator can promptly intervene on the machine.

The signal generated by the control system 20 can be an alarm signal such as, for example, a missing punch alarm, as in the case shown in FIG. 4, in which the resisting pressure value is below a first predefined value. Alternatively, the signal can be a punch malfunction alarm, if the resisting pressure value is higher than a second predefined value. The first predefined value is less than the second predefined value.

According to a further embodiment, the signal generated by the control system 20 can be a warning signal different from said alarm signal.

According to another aspect of the present invention, in said detection step the trend of the resisting pressure values for a specific empty die 4a is also evaluated, and in which said control system 20 generates said warning signal when said trend aims at going outside a predefined tolerance window, so as to intervene before the resisting pressure value goes out of said tolerance window.

Said predefined tolerance window is based on a reference resisting pressure value, indicating the optimal resisting pressure value under correct machine operating conditions. The predefined tolerance window having an amplitude such as +−10%, preferably +−5%, more preferably +−2% of said reference resisting pressure value.

Said alert signal being different from said missing punch alarm and from said punch malfunction alarm.

According to a further aspect of the present invention, said detection step and said evaluation step are preceded by an assembly step, in which one or more lower 6 and/or upper 5 punches are associated with said compression turret 2. This assembly step can for example be carried out during a replacement operation of one or more punches for maintenance operation of the machine 1 or during a size change. In other circumstances, this assembly step can be performed during the initial assembly of the machine 1, in which the punches are initially mounted on the compression turret 2. After the assembly of the punches, the detection and evaluation steps are carried out to verify the correct assembling. In this way, it is possible to detect and evaluate the correct assembly performed by an operator who mounted one or more punches on the machine 1. More precisely, it is possible to detect whether all the punches have been mounted on machine 1 before proceeding with the production of tablets, and it is also possible to detect whether all the punches associated with compression turret 2 have been correctly mounted.

1. A control method for controlling operating condition of a rotary press machine (1) for forming tablets (100) wherein the rotary press (1) comprises a rotating compression turret (2) including a die table (3) provided along a circumferential portion thereof with a plurality of dies (4), a plurality of lower punches (6) and a corresponding plurality of upper punches (5) associated in pairs with respective dies (4), said lower punches (6) and said upper punches (5) having respectively a substantially cylindrical body with an abutment end on which a lower compression roller (12) and an upper compression roller (11) respectively abut, a feeding station (7) comprising filling means for filling said dies (4), wherein during tablets production the following steps occur:
feeding powder (50) by said feeding station (7) into said dies (4);
compressing said powder (50) fed into said dies (4) by moving respective lower punches (6) and upper punches (5), exerting a compression force (Fc) along a vertical compression direction (A) on said abutment ends of said lower and upper punches (6, 5) by contacting said lower compression roller (12) and said upper compression roller (11) respectively, to compress said powder (50) fed within said at least one die (4) so as to produce tablets;
characterized by further comprising a detection step in which feeding of the powder (50) into said dies (4) is inhibited, so as to have at least an empty die (4a), said lower punches (6) and/or upper punches (5) are moved toward said at least one empty die (4a) by means of respective lower and/or upper compression means, and a resisting pressure value is measured, through detection means (14), as a value of pressure exerted by respective lower and/or upper compression means on the corresponding lower and/or upper punches (6,5) moved within said at least one empty die (4a), and an evaluation step in which said resisting pressure value is processed by a control system (20) to generate a signal correlated to a punch operation state.

2. Control method as claimed in claim 1, wherein in said evaluation step, the signal generated by said control system (20) is an indication of missing punch if the resisting pressure value is below a first predefined pressure value.

3. Control method as claimed in claim 2, wherein in said evaluation step, the signal generated by said control system (20) is an indication of malfunction punch if the resisting pressure value is above a second predefined pressure value.

4. Control method as claimed in claim 3, wherein the first predefined pressure value is lower than the second predefined pressure value.

5. Control method as claimed in claim 1, wherein in said detection step, said detection means (14) comprise a plurality of sensors associated with said lower and/or upper compression means.

6. Control method as claimed in claim 5, wherein said plurality of sensors comprises at least a load cell.

7. Control method as claimed in claim 1, wherein said upper and lower compression means correspond to said upper and lower compression rollers (11, 12) respectively.

8. Control method as claimed in claim 1, wherein in said detection step, said lower (6) and/or upper punches (5) are moved toward said at least one empty die (4a) by the respective lower and/or upper compression means by rotating said compression turret (2).

9. Control method as claimed in claim 1, wherein before said detection step and said evaluation step, one or more lower punches (6) and/or one or more upper punches (5) are installed on said compression turret (2).

10. Control method as claimed in claim 1, wherein in said evaluation step, said signal correlated to a punch operation state comprises a command to stop the rotary press (1).

11. Control method as claimed in claim 1, wherein said evaluation step comprises a data saving sub-step wherein resisting pressure values acquired during multiple detection steps for a specific empty matrix (4a) are saved in a data storage unit.

12. Control method as claimed in claim 1, wherein in said detection step, a trend of the resisting pressure values for a specific empty die (4a) is also evaluated, and wherein said control system (20) generates an alert signal when said trend aims at going outside a predefined tolerance window, so as to intervene before the resisting pressure value go out said tolerance window.
